(19) United States
(12) Patent Application Publication
(10) Pub. No.: US 2018/0012139 A1
(43) Pub. Date: Jan. 11, 2018

(54) SYSTEMS AND METHODS FOR INTENT CLASSIFICATION OF MESSAGES IN SOCIAL NETWORKING SYSTEMS

(71) Applicant: Facebook, Inc., Menlo Park, CA (US)

(72) Inventors: Matthew Logan Schmid, New York, NY (US); Akhil Nambiar, San Francisco, CA (US); Ehud Weinsberg, Menlo Park, CA (US); Tianyu Xie, Jersey City, NJ (US); Shuyang Lin, Menlo Park, CA (US)

(21) Appl. No.: 15/203,493

(22) Filed: Jul. 6, 2016

(51) Int. Cl. G06N 99/00; H04L 12/58; G06N 7/00; H04L 29/08; G06F 17/30

(52) U.S. Cl. CPC G06N 99/005; H04L 67/10; G06F 17/30598; G06N 7/005; H04L 51/32

(57) ABSTRACT

Systems, methods, and non-transitory computer-readable media according to certain aspects can receive at least one message sent by a user of a social networking system to a page provided by the social networking system, where the page is associated with an entity. A training data set including a plurality of messages can be determined, and the training data set can indicate an intent classification for each of the plurality of messages. The intent classification can be indicative of an intent associated with a particular message. A machine learning model may be trained based at least in part on the training data set. A first intent classification for the at least one message can be determined, based at least in part on the machine learning model.

### FIELD OF THE INVENTION

The present technology relates to the field of social networks. More particularly, the present technology relates to processing of messages in social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be given the opportunity to interact with profiles or pages on the social networking system that are associated with other users or entities. The profiles and pages can be dedicated locations on the social networking system to reflect the presence of the other users and entities on the social networking. A user can interact with the profiles and pages in a variety of manners. For example, a user can send a message to a page associated with a business.

### SUMMARY

Various embodiments of the present disclosure can include systems, methods, and non-transitory computer readable media configured to receive at least one message sent by a user of a social networking system to a page provided by the social networking system, where the page is associated with an entity. A training data set including a plurality of messages can be determined, and the training data set can indicate an intent classification for each of the plurality of messages. The intent classification can be indicative of an intent associated with a particular message. A machine learning model may be trained based at least in part on the training data set. A first intent classification for the at least one message can be determined, based at least in part on the machine learning model.

In an embodiment, the machine learning model provides the first intent classification and a confidence score associated with the first intent classification.

In some embodiments, the first intent classification is displayed in a user interface associated with the page when the confidence score associated with the first intent classification is greater than or equal to a threshold value.

In certain embodiments, the first intent classification is associated with the at least one message when the confidence score associated with the first intent classification is greater than or equal to a threshold value.

In other embodiments, the machine learning model provides one or more intent classifications for the at least one message and a confidence score associated with each of the intent classifications.

In an embodiment, the first intent classification is selected from intent classifications associated with the plurality of messages included in the training data set.

In some embodiments, the determining the training data set comprises performing a pattern search on one or more messages using one or more regular expressions. Each of the one or more regular expressions may be associated with a respective intent classification, and a first message of the one or more messages that includes text matching a first regular expression of the one or more regular expressions can be associated with the intent classification of the first regular expression.

In certain embodiments, the determining the training data set comprises obtaining one or more messages for which the intent classification is designated based at least in part on human input.

In an embodiment, user input relating to whether the first intent classification is indicative of an intent associated with the at least one message can be received.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an intent classification module configured to determine intent classification for messages, according to an embodiment of the present disclosure.

FIG. 2 illustrates an example message intent identification module configured to identify intent classifications for messages, according to an embodiment of the present disclosure.

FIG. 3 illustrates an example user interface for providing messages and associated intent classifications, according to an embodiment of the present disclosure.

FIG. 4 illustrates an example first method for determining intent classification for messages, according to an embodiment of the present disclosure.

FIG. 5 illustrates an example second method for determining intent classification for messages, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Message User Intent Classification Determination

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide user profiles for various users through which users may add friends or contacts, or provide, post, or publish content items.

The social networking system may also provide pages for various entities. For example, pages may be associated with companies, businesses, brands, products, artists, public figures, entertainment, individuals, and other types of entities. The pages can be dedicated locations on the social networking system to reflect the presence of the entities on the social networking system. The pages can publish content that is deemed relevant to the associated entities to promote interaction with the pages. In this regard, users can interact with the pages. For example, users may send messages to pages, and administrators for the pages can review and process the messages. In one example, a page for a business can receive a number of messages from different users regarding various products and services offered by the business.

In many cases, conventional approaches specifically arising in the realm of computer technology may provide messages sent by users to the pages without further computer processing to determine the substance or meaning of these messages. For example, a page can receive a large number of messages on a given day, and an administrator associated with the page may be left with the daunting task of manually sorting through and responding to the messages appropriately. When administrators of pages receive voluminous amounts of messages from users about products, services, customer service, jobs, etc. regarding the pages, the page administrators are often not able to timely process and respond to the messages. Further, when the amount of messages is large, page administrators may be prevented from appropriately identifying and responding to messages that are relatively more urgent or that require action on their part. The challenge in processing the messages is based in large part on the inability of page administrators to readily access information regarding user intent behind the messages.

An improved approach rooted in computer technology can overcome the foregoing and other disadvantages associated with conventional approaches specifically arising in the realm of computer technology. Based on computer technology, the disclosed technology can classify messages based on potential user intent associated with the messages and provide information relating to the potential user intent. An intent classification can be determined and associated with each message. For example, when a user sends a message to a page of a business asking about the price for a product, the intent of the user may be to find out about prices. In this example, the intent classification for the message can be “prices.” Intent classifications for messages can be used in processing the messages. For instance, an administrator of the page may decide to respond to messages with the “prices” intent classification first and respond to messages with a “shipping” intent classification later, or vice versa. The intent classifications can help page administrators quickly obtain information about why users sent messages and respond appropriately. A machine learning model may be used in determining intent classifications. The machine learning model can be trained based on a training data set including a plurality of messages. The training data set can indicate an intent classification for each of the plurality of messages. The machine learning model can provide a confidence level regarding a determination of an intent classification. In certain cases, the intent classifications are provided to page administrators only if they meet a particular confidence level. In this way, the disclosed technology can provide information about possible user intent or purpose for messages, which can be used to determine how to process or prioritize the messages.

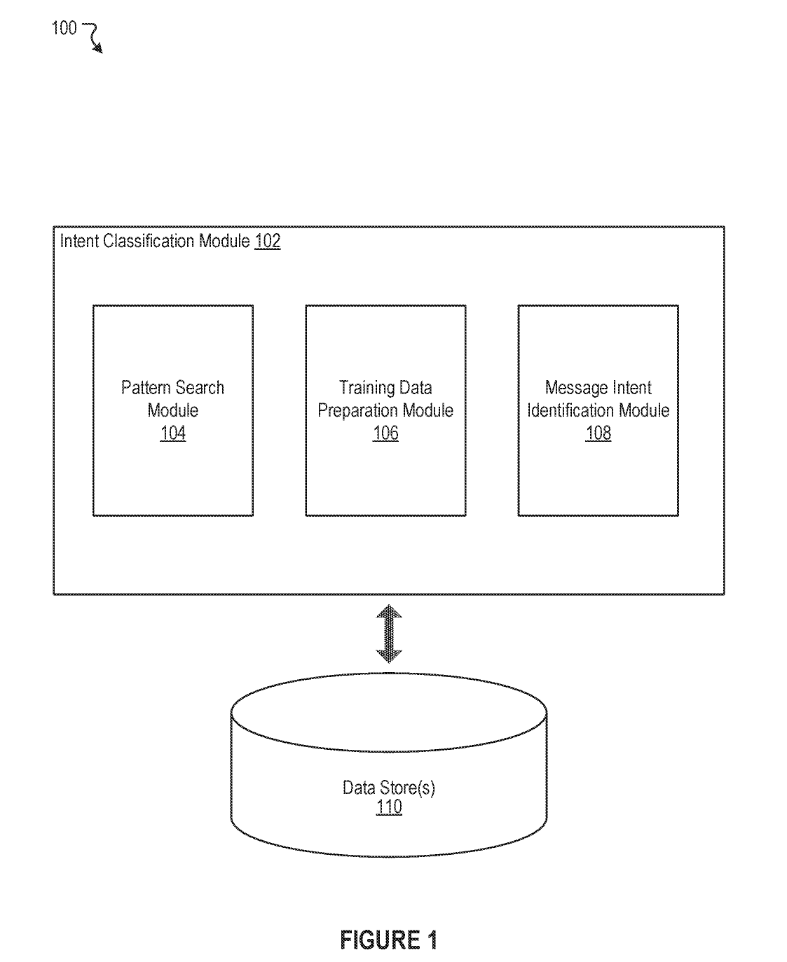

FIG. 1 illustrates an example system 100 including an example intent classification module 102 configured to determine intent classification for messages, according to an embodiment of the present disclosure. The intent classification module 102 may identify intent classifications for messages sent to pages and classify the messages based on the intent classifications. An intent classification can indicate a user intent reflected in a message. Provision of intent classifications for messages can be helpful to administrators of pages, who may have limited resources in responding to messages sent to the pages. Page administrators can refer to the intent classifications to decide which messages are urgent and prioritize the messages accordingly.

The intent classification module 102 can use one or more machine learning models in order to automatically determine intent classifications. The intent classification module 102 may prepare a training data set that is provided to machine learning models. Such training data set can include, for example, data based on pattern search, data based on human input, or both. The intent classification module 102 can determine intent classifications with high accuracy in order to provide correct, reliable user intent information. For example, the intent classification module 102 can allow an administrator of a page to know that a determination of a “prices” intent classification for a message to the page is a true reflection of user intent behind the message so that reliance on the determination can be made with high confidence. Accordingly, the training data set may be compiled and prepared such that the machine learning models can determine intent classifications with high accuracy.

The intent classification module 102 can determine various intent classifications. For example, for messages to pages associated with a business or other organization, the intent classifications can include prices, availability (of products, services, etc.), sales inquiry, purchase, payments, shipping, exchange, refund, appointments, feedback, customer service, hours, location, contact information, help, jobs, etc. Other intent classifications for messages to pages associated with other types of entities are possible. The examples described herein in connection with messages sent to pages are for illustrative purposes, but the techniques described in this disclosure may also be applicable to any type of messages sent and received via any system involving communication, including a social networking system. Intent classification information may be helpful to users other than page administrators and can also be utilized by such users. In addition, the techniques described in this disclosure may be used with different languages. There can be many variations and possibilities.

As shown in the example of FIG. 1, the intent classification module 102 can include a pattern search module 104, a training data preparation module 106, and a message intent identification module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

The pattern search module 104 can be configured to perform a pattern search or pattern matching on messages sent to a page. The pattern search can be used to identify intent classifications for one or more messages. For example, the pattern search is performed on the text of the messages using regular expressions. In certain embodiments, a regular expression may refer to a sequence of characters that define a search pattern for use in pattern matching with strings or string matching. Each character in a regular expression can be a metacharacter (e.g., “?”, “*”, etc.) or a regular character (e.g., “a”-“z”, etc.). A metacharacter can have a special meaning, and a regular or ordinary character can have its literal meaning. Metacharacters and regular characters can be used to identify textual material of a given pattern or to process a number of instances of the pattern. Pattern matches may vary from a precise equality to a very general similarity, depending on the metacharacters.

The pattern search module 104 can perform a pattern search to determine whether the text of a message matches one or more regular expressions. Each regular expression may be associated with an intent classification. If the text of a message matches a regular expression, then the pattern search module 104 can assign or label the message with the intent classification associated with the regular expression. One or more messages for which the intent classification is identified using pattern search can be included in a training data set to train a machine learning model for identifying intent classifications.

Regular expressions can be identical to, similar to, or otherwise indicative of the intent classification to which they relate. A regular expression can be based on a word, a phrase, or a sentence. For example, for the “prices” intent classification, a regular expression can be defined based on the word “price,” the phrase “how much,” etc. A message that includes one or more strings having text that match the regular expression can be assigned the “prices” intent classification. Multiple regular expressions may be used to identify the same intent; for example, each of the multiple regular expressions can be associated with or mapped to the same intent. In the examples above, both the regular expression based on the word “price” and the regular expression based on the phrase “how much” can be associated with the “prices” intent classification.

The pattern search module 104 can assign one or more intent classifications to messages based on regular expressions associated with the intent classifications. For example, if a message matches two or more regular expressions associated with one intent classification, then the intent classification may be assigned to the message. As another example, if a message matches two or more regular expressions associated with two or more intent classifications, then the two or more intent classifications may be assigned to the message.

The pattern search module 104 can allow regular expressions to be adjusted appropriately in order to obtain desired results. Often there can be a tradeoff between accuracy and coverage for a regular expression. If a regular expression associated with an intent is broader, it can cover or have many matching messages, but may also identify messages that are not highly related to the intent. On the other hand, if a regular expression is narrower, it may identify messages that are highly related to the intent, but may not include all messages that may match the intent. Regular expressions can be edited or modified to achieve the desired balance between accuracy and coverage. For example, if a particular intent classification associated with a message does not seem to accurately reflect the user intent, regular expressions may be changed to achieve higher precision and reduce noise. In some embodiments, adjustments to regular expressions performed by the pattern search module 104 can be based on manual or machine learning techniques.

The training data preparation module 106 can be configured to compile and prepare a training data set to train a machine learning model. The training data set can include some or all messages sent to selected pages and their associated intent classifications. The messages in the training data set may be selected randomly or based on any suitable criteria.

As explained above, the training data set can include messages that are labeled by the pattern search module 104 with intent classifications using pattern search. In some instances, it may be difficult to identify an intent classification for all messages using pattern search. For example, the user intent for some messages may be related to customer service, but there can be many scenarios involving customer service. Accordingly, it may be challenging to define regular expressions that can identify all or most of messages related to customer service. Therefore, in certain cases, a person can manually review a message to assign an appropriate intent classification. The training data preparation module 106 accordingly can include in the training data set messages that have been labeled with intent classifications based on manual review. In certain embodiments, selected messages may be labeled with intent classifications using pattern search first, and any messages that have not been labeled through the pattern search can be labeled based on manual review.

The training data preparation module 106 can adjust the number of different intent classifications included in the training data set to obtain desired results. For broad coverage of intents, a large number of intent classifications may be used. For narrower or more focused coverage of intents, a fewer number of intent classifications may be used. In certain embodiments, a specific intent classification may be divided into subcategories. For instance, in an example relating to a page associated with a business, the “prices” intent classification can be divided into subcategories of intent classifications for prices relating to different products carried by the business.

The message intent identification module 108 can be configured to train a machine learning model and identify intent classifications for various messages. The message intent identification module 108 can train the machine learning model based on a training data set provided by the training data preparation module 106. Once trained, the machine learning model can be applied to messages sent to pages in order to identify one or more possible intent classifications for the messages. The message intent identification module 108 is discussed in greater detail herein.

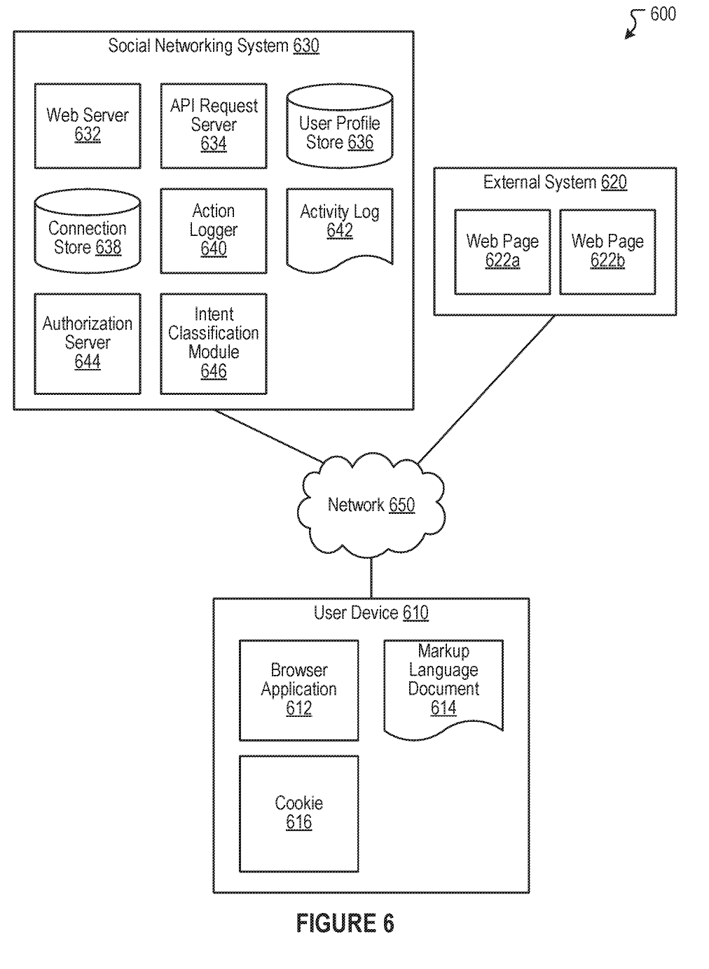

The intent classification module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the intent classification module 102 can be implemented, in part or in whole, as software running on one or more computing devices or systems, such as on a server computing system or a user (or client) computing system. For example, the intent classification module 102 or at least a portion thereof can be implemented as or within an application (e.g., app), a program, or an applet, etc., running on a user computing device or a client computing system, such as the user device 610 of FIG. 6. In another example, the intent classification module 102 or at least a portion thereof can be implemented using one or more computing devices or systems that include one or more servers, such as network servers or cloud servers. In some instances, the intent classification module 102 can, in part or in whole, be implemented within or configured to operate in conjunction with a social networking system (or service), such as the social networking system 630 of FIG. 6. It should be understood that there can be many variations or other possibilities.

The intent classification module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user locations, user specified settings, content produced or posted by users, and various other types of user data. In some embodiments, the data store 110 can store information that is utilized by the intent classification module 102. For example, the data store 110 can store data relating to pages, messages sent to pages, regular expressions, training data sets including messages labeled with intent classifications, machine learning models, intent classifications, and the like. It is contemplated that there can be many variations or other possibilities.

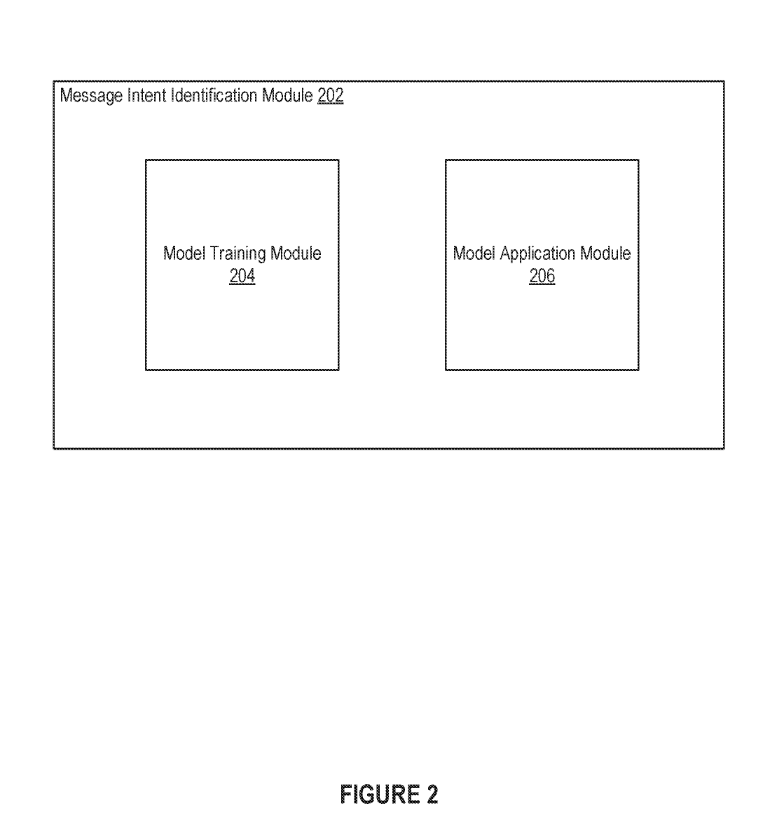

FIG. 2 illustrates an example message intent identification module 202 configured to identify intent classifications for messages, according to an embodiment of the present disclosure. In some embodiments, the message intent identification module 108 of FIG. 1 can be implemented as the example message intent identification module 202. As shown in FIG. 2, the message intent identification module 202 can include a model training module 204 and a model application module 206.

The model training module 204 can be configured to train one or more machine learning models based on a training data set. The machine learning models can be trained, using the training data set, to identify one or more possible intent classifications for messages. In some embodiments, the machine learning models may be classifiers. The model training module 204 can train the machine learning models based on any suitable machine learning technique. In some embodiments, a suitable machine learning technique can include artificial neural networks, such as deep neural networks. In some embodiments, the machine learning techniques can be supervised or at least partially supervised. In other instances, the machine learning techniques can be at least partially unsupervised. The machine learning models may be configured to output one or more potential intent classifications for each message. The one or more intent classifications can be selected from the intent classifications that are included in the training data set.

In some embodiments, the machine learning models may also output a confidence score associated with an intent classification. The confidence score can indicate a probability of the identified intent classification accurately reflecting the user intent behind a message. For instance, if a machine learning model determines an intent classification for a message, then the machine learning model can determine a confidence score for the intent classification. As another example, if the machine learning model determines a list of intent classifications, the machine learning model can determine a confidence score for each intent classification in the list.

The model application module 206 can be configured to identify one or more possible intent classifications associated with a message based on the trained machine learning models. The model application module 206 can apply one or more trained machine learning models to messages sent to pages. As explained above, for each message, the machine learning models can determine one or more intent classifications and/or a confidence score associated with the one or more intent classifications. In some embodiments, if the machine learning models output more than one possible intent classification for a particular message, the model application module 206 selects one and assigns it to the message. For instance, the model application module 206 selects the intent classification with the highest confidence score. In other embodiments, two or more intent classifications can be assigned to the message, for example, if the confidence scores for the intent classifications are the same or similar. In certain embodiments, the model application module 206 assigns one or more intent classifications to a message only if one or more confidence scores associated with the one or more intent classifications satisfy a threshold level of confidence.

In one example, given the message “do you still have these, and how soon can you deliver,” the model application module 206 outputs a list of the following intent classifications and their associated confidence scores: sales inquiry—99% confidence; shipping—90% confidence. In another example, given the message “do you have these, and how much do they cost,” the model application module 206 outputs a list of the following intent classifications and their associated confidence scores: availability—95% confidence; prices—99% confidence.

In some embodiments, the model application module 206 may output all intent classifications in the set of possible intent classifications and their associated confidence scores. In some cases, page administrators, administrators of the social networking system, or other personnel may want to know what the confidence scores are for all intent classifications that are available. In the example above, for the message “do you still have these, and how soon can you deliver,” the model application module 206 may output a list of the following intent classifications and their associated confidence scores: sales inquiry—99% confidence; prices—0% confidence; shipping—90% confidence. The “prices” intent classification and the associated confidence score are provided to the page administrators, the administrators of the social networking system, or the other personnel even if the likelihood of the “prices” intent classification being assigned to the message is very low. All examples herein are provided for illustrative purposes, and there can be many variations or other possibilities.

In some embodiments, an intent classification is associated with a message only if it meets a selected level of confidence. If a confidence score associated with an identified intent classification for a message satisfies a threshold value, the identified intent classification is assigned to the message. If a confidence score associated with an identified intent classification for a message is below a threshold value, the identified intent classification is not assigned to the message.

An intent classification can be displayed in connection with a message. For example, the intent classification is displayed as a tag or label. In one example, a message assigned the “prices” intent classification is displayed with a “prices” tag or label on or adjacent to the message. In some embodiments, an intent classification is displayed only if it meets a selected level of confidence. For instance, the intent classification is displayed to an administrator of a page if the confidence score associated with the intent classification exceeds a threshold value (e.g., greater than, greater than or equal to, etc.). The threshold values may be selected to provide high accuracy. In one example, the threshold value is 90%. In some embodiments, the intent classification can be displayed with an indication relating to confidence level (e.g., percentage, high/medium/low, etc.). For example, if a confidence score for the intent classification exceeds the threshold value, the intent classification may be provided with an indication of high confidence, and if the confidence score for the intent classification does not exceed the threshold value, the intent classification may be provided with an indication of low confidence. In certain embodiments, the intent classification is displayed in connection with the message even if the confidence score for the intent classification does not satisfy a threshold value. In some cases, multiple threshold values may be used for various levels of confidence, and an intent classification may be provided with an indication associated with a level of confidence for a satisfied threshold value. The threshold values may be determined by the intent classification module 102 or manually. The threshold values may be selected based on any suitable factors. The threshold values may be selected such that an intent classification provided to page administrators has a sufficient confidence level to allow the page administrators to take action with respect to the message associated with the intent classification.

The machine learning models may be adjusted or retrained based on the results of the intent classifications provided by the models. If the models are not producing the desired intent classifications for the messages, the training data set may be adjusted as appropriate, and the models can be retrained based on the new training data set.

In one embodiment, the intent classification is determined by also considering the content of adjacent messages. In some cases, it may be difficult for the machine learning models to identify an intent classification based on the text of the message alone. In such cases, one or more adjacent messages (e.g., in the same message thread) can be provided to the machine learning models, and the models may determine an intent classification for the message based on the text of the adjacent messages.

Various features can be implemented in association with intent classifications. For example, page administrators can tailor the present technology according to the preferences or requirements of their pages. In certain embodiments, page administrators may also be able to define their own intent classifications, and the machine learning models may classify messages based on the intent classifications defined by the page administrators, for example, in addition to system provided intent classifications. Individualized machine learning models may be provided for different pages. In some embodiments, the page administrator may have the option to provide automated responses to messages based on intent classifications determined for the messages. For instance, the page administrator can define an automated response to be provided for a message associated with a particular intent classification (e.g., whether system provided or administrator defined). In certain embodiments, the page administrators can receive notifications relating to particular intent classifications associated with messages, for example, by email, text, phone call, etc. In an embodiment, advertisements can be provided to users who visit a page based on intent classifications associated with messages provided by the users to the page.

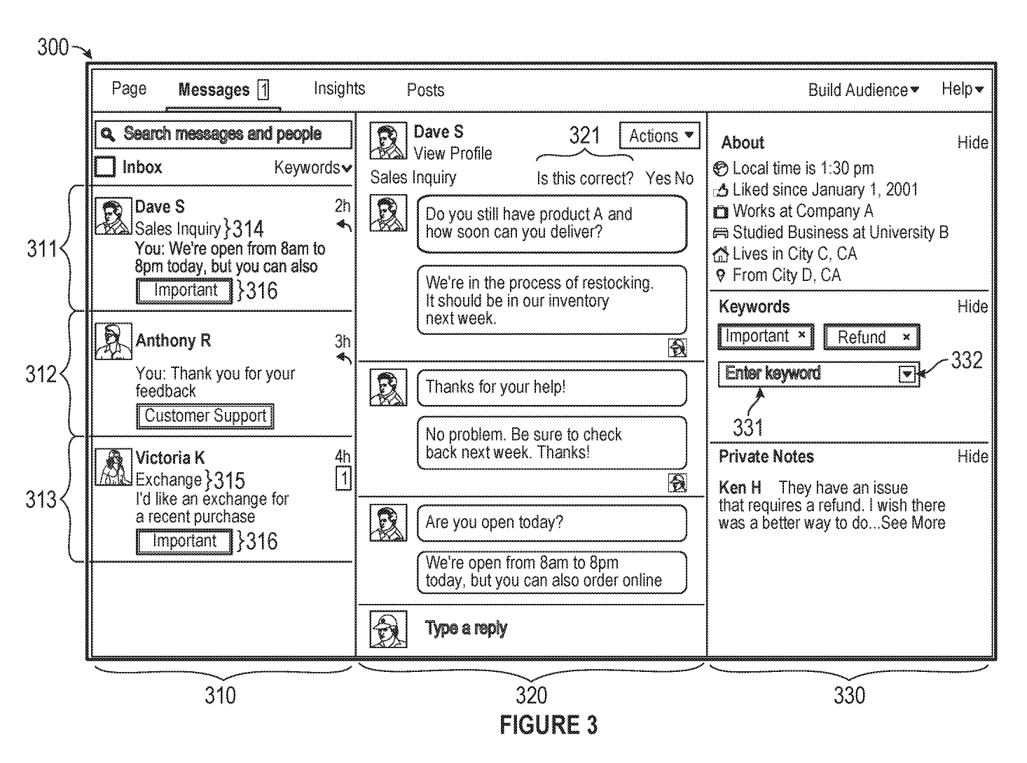

FIG. 3 illustrates an example user interface 300 for providing messages and associated intent classifications, according to an embodiment of the present disclosure. The user interface 300 illustrates a page associated with a business for illustrative purposes, but the techniques described in this disclosure can be used with any type of page. A section 310 displays a list of messages sent to the page. A section 320 displays the thread for a message that is selected from the list of messages. A section 330 displays information about a user who sent the selected message and/or other information relevant to the page.

In some embodiments, if the confidence level for an intent classification associated with a message satisfies a threshold, an indication of the intent classification can be added to the message. As explained above, the intent classification can be provided as a tag or label. For example, if a message has been assigned the “prices” intent classification, the message can be displayed in the user interface 300 with a “prices” tag or label.

In certain embodiments, the intent classification can be provided as a subject of the message. In the example of FIG. 3, a message 311 from Dave S. reflects a determination of an intent classification 314 of “Sales Inquiry” for the message 311 and a message 313 from Victoria K. reflects a determination of an intent classification 315 of “Exchange” for the message 313. These intent classifications can be displayed as subjects of their respective messages. The intent classifications and associated messages can be deemed to have a certain priority level by the page. In this example, the message 311 and the message 313 can be displayed with a tag (or label) 316 indicating that the priority level of the message is important. Accordingly, the message 311 and the message 313 are displayed with an “Important” tag or label. In other examples, a message may be displayed with tags or labels indicating other priority levels (e.g., standard, low priority, etc.).

In some cases, the intent classification provided for the message may not match the user intent, and the user interface 300 can provide a mechanism for an administrator of the page to provide feedback regarding whether a displayed intent classification is correct. For example, the section 320 in the user interface 300 displays a question 321 “Is this correct,” and the page administrator can click “Yes” or “No.” Information from page administrators regarding correctness of intent classifications reflected by tags, labels, and/or subjects may be used to train and retrain the machine learning models.

In some embodiments, page administrators can search for messages that are assigned a particular intent classification. For instance, the section 330 includes a keyword search utility based on intent classifications. The page administrator may perform a keyword search by typing in a keyword search bar 331 a keyword for a specific intent classification or selecting an intent classification from a dropdown menu 332. Messages that have been assigned the intent classification associated with the entered keyword or the selected intent classification may be returned for display in the user interface 300, for example, in the section 310 or the section 330. Likewise, an indication of a priority level for messages can be used in a keyword search to return messages associated with the priority level. All examples herein are provided for illustrative purposes, and there can be many variations or other possibilities.

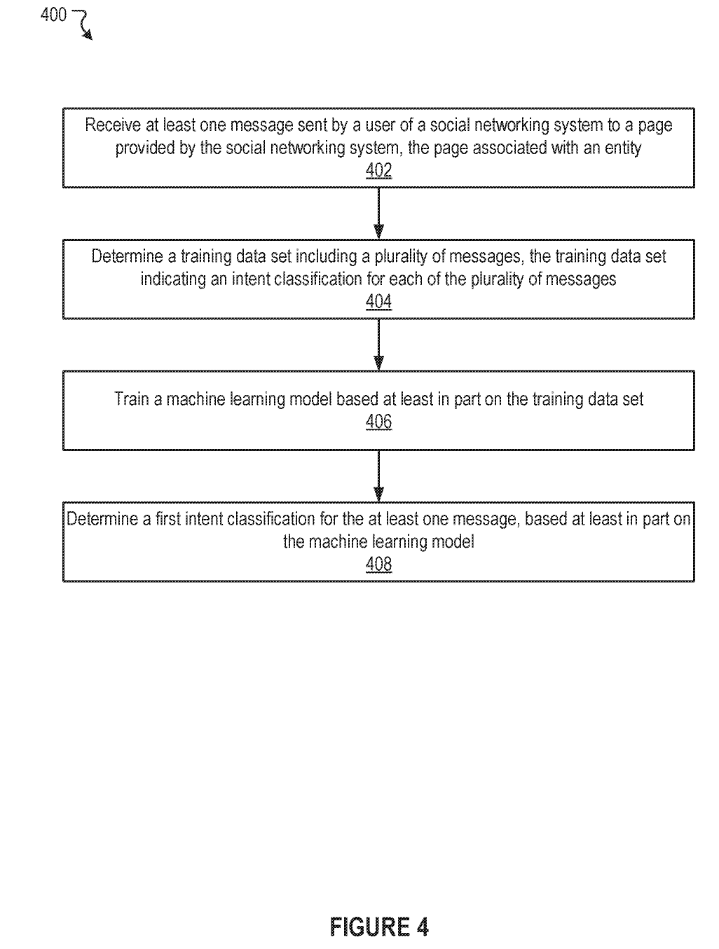

FIG. 4 illustrates an example first method 400 for determining intent classification for messages, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can receive at least one message sent by a user of a social networking system to a page provided by the social networking system. The page may be associated with an entity. At block 404, the example method 400 can determine a training data set including a plurality of messages. The training data set can indicate an intent classification for each of the plurality of messages. The intent classification can be indicative of an intent associated with a particular message. At block 406, the example method 400 can train a machine learning model based at least in part on the training data set. At block 408, the example method 400 can determine a first intent classification for the at least one message, based at least in part on the machine learning model. Other suitable techniques that incorporate various features and embodiments of the present technology are possible.

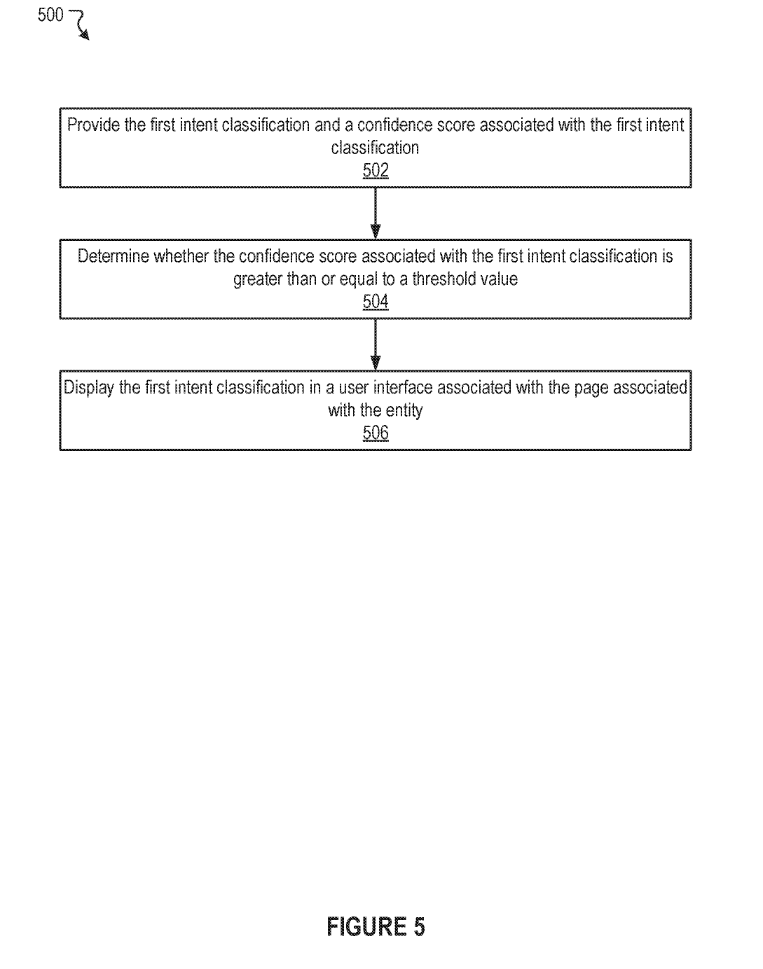

FIG. 5 illustrates an example second method 500 for determining intent classification for messages, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can provide the first intent classification and a confidence score associated with the first intent classification. The first intent classification can be similar to the first intent classification explained in connection with FIG. 4. At block 504, the example method 500 can determine whether the confidence score associated with the first intent classification is greater than or equal to a threshold value. At block 506, the example method 500 can display the first intent classification in a user interface associated with the page associated with the entity, for example, in response to determining that the confidence score associated with the first intent classification is greater than or equal to the threshold value. The page can be similar to the page explained in connection with FIG. 4. Other suitable techniques that incorporate various features and embodiments of the present technology are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System

### Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include intent classification module 646. The intent classification module 646 can, for example, be implemented as the intent classification module 102, as discussed in more detail herein. As discussed previously, it should be appreciated that there can be many variations or other possibilities. For example, in some embodiments, one or more functionalities of the intent classification module 646 can be implemented in the user device 610.

### Hardware Implementation

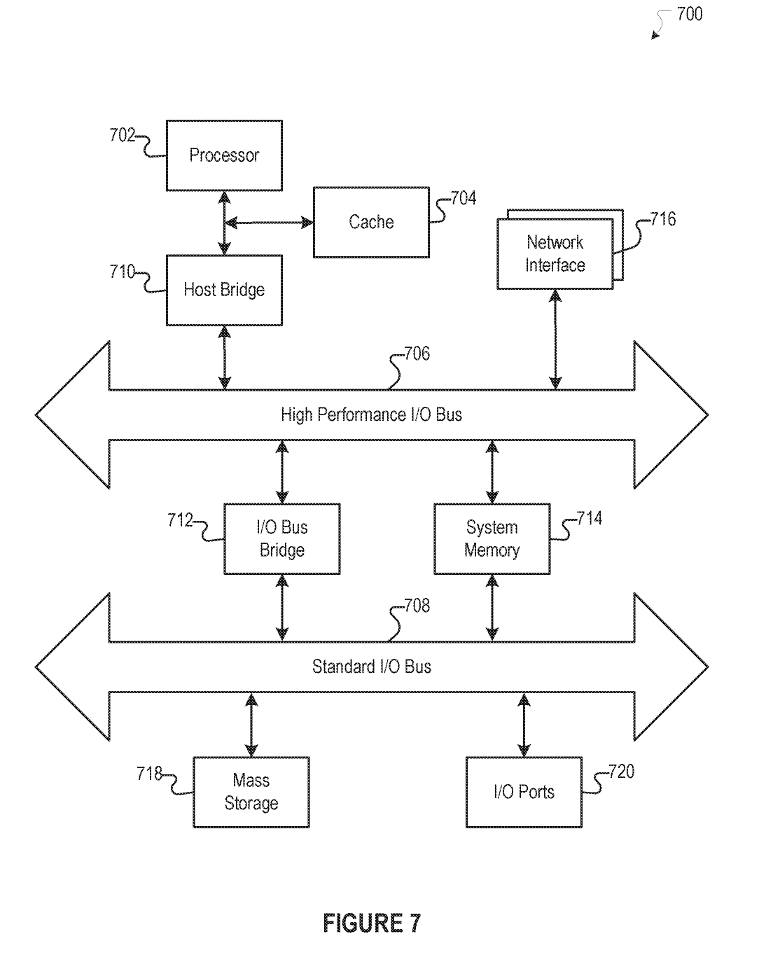

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, at least one message sent by a user of a social networking system to a page provided by the social networking system, the page associated with an entity;
determining, by the computing system, a training data set including a plurality of messages, the training data set indicating an intent classification for each of the plurality of messages, the intent classification indicative of an intent associated with a particular message;
training, by the computing system, a machine learning model based at least in part on the training data set; and
determining, by the computing system, a first intent classification for the at least one message, based at least in part on the machine learning model.

2. The computer-implemented method of claim 1, wherein the machine learning model provides the first intent classification and a confidence score associated with the first intent classification.

3. The computer-implemented method of claim 2, wherein the first intent classification is displayed in a user interface associated with the page when the confidence score associated with the first intent classification is greater than or equal to a threshold value.

4. The computer-implemented method of claim 2, wherein the first intent classification is associated with the at least one message when the confidence score associated with the first intent classification is greater than or equal to a threshold value.

5. The computer-implemented method of claim 2, wherein the machine learning model provides one or more intent classifications for the at least one message and a confidence score associated with each of the intent classifications.

6. The computer-implemented method of claim 1, wherein the first intent classification is selected from intent classifications associated with the plurality of messages included in the training data set.

7. The computer-implemented method of claim 1, wherein the determining the training data set comprises performing a pattern search on one or more messages using one or more regular expressions.

8. The computer-implemented method of claim 7, wherein each of the one or more regular expressions is associated with a respective intent classification, and wherein a first message of the one or more messages that includes text matching a first regular expression of the one or more regular expressions is associated with the intent classification of the first regular expression.

9. The computer-implemented method of claim 1, wherein the determining the training data set comprises obtaining one or more messages for which the intent classification is designated based at least in part on human input.

10. The computer-implemented method of claim 1, further comprising receiving user input relating to whether the first intent classification is indicative of an intent associated with the at least one message.

11. A system comprising:
at least one hardware processor; and
a memory storing instructions that, when executed by the at least one processor, cause the system to:
receive at least one message sent by a user of a social networking system to a page provided by the social networking system, the page associated with an entity;
determine a training data set including a plurality of messages, the training data set indicating an intent classification for each of the plurality of messages, the intent classification indicative of an intent associated with a particular message;
train a machine learning model based at least in part on the training data set; and
determine a first intent classification for the at least one message, based at least in part on the machine learning model.

12. The system of claim 11, wherein the machine learning model provides the first intent classification and a confidence score associated with the first intent classification.

13. The system of claim 12, wherein the first intent classification is displayed in a user interface associated with the page when the confidence score associated with the first intent classification is greater than or equal to a threshold value.

14. The system of claim 12, wherein the first intent classification is associated with the at least one message when the confidence score associated with the first intent classification is greater than or equal to a threshold value.

15. The system of claim 11, wherein the determination of the training data set comprises performing a pattern search on one or more messages using one or more regular expressions.

16. A non-transitory computer readable medium including instructions that, when executed by at least one hardware processor of a computing system, cause the computing system to:
receive at least one message sent by a user of a social networking system to a page provided by the social networking system, the page associated with an entity;
determine a training data set including a plurality of messages, the training data set indicating an intent classification for each of the plurality of messages, the intent classification indicative of an intent associated with a particular message;
train a machine learning model based at least in part on the training data set; and
determine a first intent classification for the at least one message, based at least in part on the machine learning model.

17. The non-transitory computer readable medium of claim 16, wherein the machine learning model provides the first intent classification and a confidence score associated with the first intent classification.

18. The non-transitory computer readable medium of claim 17, wherein the first intent classification is displayed in a user interface associated with the page when the confidence score associated with the first intent classification is greater than or equal to a threshold value.

19. The non-transitory computer readable medium of claim 17, wherein the first intent classification is associated with the at least one message when the confidence score associated with the first intent classification is greater than or equal to a threshold value.

20. The non-transitory computer readable medium of claim 16, wherein the determination of the training data set comprises performing a pattern search on one or more messages using one or more regular expressions.
